(19) United States
(12) Patent Application Publication
(10) Pub. No.: US 2005/0099041 A1
(43) Pub. Date: May 12, 2005

(54) Motor vehicle seat with occupant weight detection system

(76) Inventors: Burckhard Becker, Solingen (DE); Michael Weber, Solingen (DE); Oliver Waschnweski, Velbert (DE)

Correspondence Address: CANTOR COLBURN, LLP, 55 GRIFFIN ROAD SOUTH, BLOOMFIELD, CT, 06002, US

(21) Appl. No.: 10/979,557

(22) Filed: Nov. 2, 2004

(30) Foreign Application Priority Data
Nov. 11, 2003 (DE) 103 52 938.1

(51) Int. Cl. B60N 2/24

(52) U.S. Cl. 297/217.2

(57) ABSTRACT

A motor vehicle seat with an occupant weight detection system is provided, said motor vehicle seat having an underframe that includes a lengthwise adjustment device with two pairs of rails each having a floor profile and a seat profile, a seat pan carried on the underframe a backrest, and, between the seat pan and the two seat profiles, there are provided weight sensors that are disposed vertically and detect all weight forces exerted from the seat pan downward.

The invention relates to a motor vehicle seat with occupant weight detection system, the motor vehicle seat having an underframe, a seat pan carried on said underframe and a backrest. The underframe comprises a lengthwise adjustment device, it has two pairs of rails, each comprising a floor profile and a seat profile. The seat pan is located beneath the occupant's buttocks and the major part of his thighs. The seat pan absorbs the weight exerted downward by the total weight of the occupant through the occupant's buttocks and the major part of his thighs. The remainder of the occupant's total weight passes in parts into the backrest and in parts through the occupant's feet directly into an underbody of the motor vehicle.

A vehicle seat comprising a seat part element is known from DE 4237072 C1. Said seat part element has foil-type resistor elements that change the electrical resistance depending on the load. Estimation of the weight load placed on a vehicle seat is thus made possible.

Motor vehicles with weight detection systems are also known from DE 4409971 C2, DE 19602088 C2 and from DE 19847603.

In the motor vehicle seat of the type mentioned herein above such as is already known from DE 19847603 A1, a seat pan is connected to the underframe by a hinge, the axis of said hinge extending across the direction of the vehicle and being located approximately beneath the backrest. A weight sensor for signaling the deflection of the seat pan is mounted so as to be offset with respect to the hinge axis.

The objective is to achieve as accurate as possible a measurement of the weight of an occupant seated on a motor vehicle seat. This is where prior art detection devices are being criticized. They are not precise enough. With a motor vehicle seat of the type mentioned herein above, the distance between the hinge axis and the point where the weight is applied is of paramount importance. If the occupant moves slightly forward in the seat or if he solely bends forward, the weight will be sensed to be greater since the device measures torques and not the weight.

Since solely part of the occupant's weight, even though it is a considerable part thereof, is applied onto a seat pan, this part must be sensed with the greatest possible accuracy in order to deduce therefrom the actual total weight of the occupant. The greater the error in detecting the portion of total weight acting onto the seat pan, the greater also the total error, meaning the more incorrect the estimation of the total weight.

This is where the invention comes in. It is the object of the invention to further develop the vehicle seat of the type mentioned herein above so as to enable as accurate as possible a detection of the weight acting onto the seat pan. The weight detection is intended to be independent of the place at which the weight is exerted onto the seat pan.

In view of the motor vehicle seat of the type mentioned herein above, this object is solved by disposing weight sensors between the seat pan and the two seat profiles, said weight sensors being disposed vertically and detecting all of the weight forces exerted from the seat pan downward.

Accordingly, the seat pan is connected either directly or indirectly to the two seat profiles through weight sensors solely. The seat pan actually forms a weighing scale. The weight the occupant brings to this scale is detected. Since the seat scale is associated with the two seat profiles through the weight sensors solely, the accuracy of the detection of the weight applied to the seat pan is substantially solely depending on the weight sensors. Since quite precise weight sensors are commercially available, it is possible to achieve very good detection sensitivity to the weight exerted by an occupant onto the seat pan. This however also permits to achieve a more precise estimation of the total weight to be detected than hereto possible.

As described herein, the connection between the seat pan and the two seat profiles is established solely through the weight sensors, which means that a parting surface containing solely weight sensors may be laid between the seat pan and the two seat profiles. In other words, the connection between the seat pan and the two seat profiles can always be released by dismounting the weight sensors. As soon as the weight sensors are dismounted, the mechanical connection between the seat pan and the two seat profiles no longer exists.

Weight sensors are to be understood as sensors that are responsive to tensile and compressive strain and that are positioned vertically in the normal position of the vehicle. Put another way, they are oriented in the direction of gravity.

Normally, the weight sensors solely record pressure although they are also subjected to tensile strain, for example in the event of an accident or of unusual loading of the seat such as when the occupant's back engages with the backrest. The weight sensors are designed to be mechanically so strong and so stable that they are capable of transmitting crash forces. Even if the seat belt is acting directly on the seat pan, the strength of the weight sensors is sufficient to even permit the transmission of crash forces. The weight sensor is further designed in such a manner that it remains operative in the event of light accidents. Mechanically, the weight sensor therefore behaves in a manner analogous to a stud of sufficient cross section that could be inserted at the same place as the weight sensor.

The great advantage of the invention is that conventional constructions of motor vehicle seats may be largely utilized. This is not possible with the motor vehicle seat of the type mentioned herein above according to DE 19847603 for example. In this respect, the invention provides for an important improvement.

In a preferred embodiment, a total of four weight sensors are provided. These are preferably secured to the corner regions of the seat pans, underneath the corner regions or directly to the two seat profiles. The utilization of four weight sensors reduces the mechanical requirements placed on the seat pan. The weight sensors are arranged in such a manner that, when the seat pan is normally loaded, solely vertically acting portions of the weight forces are, as far as practicable, transmitted through the weight sensors and that the share of components in the horizontal plane is as low as possible. In principle, the invention is not limited to the number of weight sensors though.

In a preferred embodiment, the weight sensors are directly connected to the seat pan, said seat pan being more specifically connected to the underframe through four weight sensors solely. In another preferred embodiment, the weight sensors are connected directly to the seat profile, two weight sensors being more specifically disposed on a respective one of the two seat profiles.

In another preferred embodiment, there is provided at least one tie bar connecting the seat profiles of the two pairs of rails, said tie bar connecting directly or indirectly to the seat pan solely through at least one weight sensor. Preferably two tie bars are provided, with each tie bar connecting to the seat pan through two weight sensors. The tie bar provides a basis for supporting preferably directly the seat pan. The weight is determined relative to this basis. This construction shows a fundamental principle of the invention, the underframe being configured in such a manner that it forms a basis relative to which the seat pan may be sensed directly or indirectly and so that the weight may be determined by the weight sensors. This principle is also realized if the underframe comprises a height-adjustment device. A left part and a right part of said height-adjustment device are thereby connected by at least one tie bar or carrier member. A side part of a height-adjustment device may also be utilized as a tie bar. Eventually, in an embodiment in which each side profile is directly connected to two weight sensors, it is also possible to dispose, above said weight sensors, an intermediate profile or a tie bar onto which the other parts of the underframe are then mounted or on which the seat pan is directly disposed.

The seat pan is provided with a padding located on the seat pan. As is well known, said padding has a cover. Said cover encloses the seat pan in such a manner that, although it covers the seat pan, it does not exert any force onto it. The seat pan is thus visually concealed without being force-loaded by the cover. In order to achieve this, the cover is provided with sufficient give and has folds and the like.

The advantage of the seat pan of the invention lies in the fact that what is termed the H point, meaning the approximate position of the hip bone of an occupant when seated, does not change substantially if a motor vehicle seat is additionally equipped with the weight detection system in accordance with the invention. Weight sensors are commercially available that are of relatively small construction and can be included in the construction. By arranging for example the weight sensors somewhat outside of the region that is normally occupied by the occupant's buttocks and thighs, one may configure the padding to be slightly thinner there, thus compensating for the increased overall height, which is due to the weight sensors. For the occupant, the comfort is hardly compromised. The weight sensors are preferably arranged on the border.

The seat pan should be mechanically stable and strong enough not to warp considerably under a load exerted by the occupant onto the seat pan. Material thickness and shape make it rigid enough not to be substantially deformed when subjected to the occupant's weight. This also permits the weight sensors to be substantially loaded in the vertical direction, with but a small lateral load, meaning a small buckling, occurring.

The weight sensors used are for example semiconductor sensors as they are available from Texas Instruments Inc. The AWS sensor for seat occupancy recognition available from Siemens VDO is another possible sensor that may be used. Other sensors relying on other fundamental physical principles such as with resistance strain gauges, with detection of the pressure of a liquid or electrodynamically with a moving coil, are also possible. The weight sensors should, as far as possible, comprise a short overall length, the actual body for instance should have a length ranging from 15 to 30 mm and a diameter of about 25 millimeters for example. Such type bodies are advantageous to incorporate in existing seat structures. Suited sensors are for example those of the type MSG available from the already mentioned Texas Instruments Inc.

Further advantages and characteristics of the invention will become more apparent upon reading the claims and the following non restrictive description of embodiments thereof, given by way of example only with reference to the drawings in which:

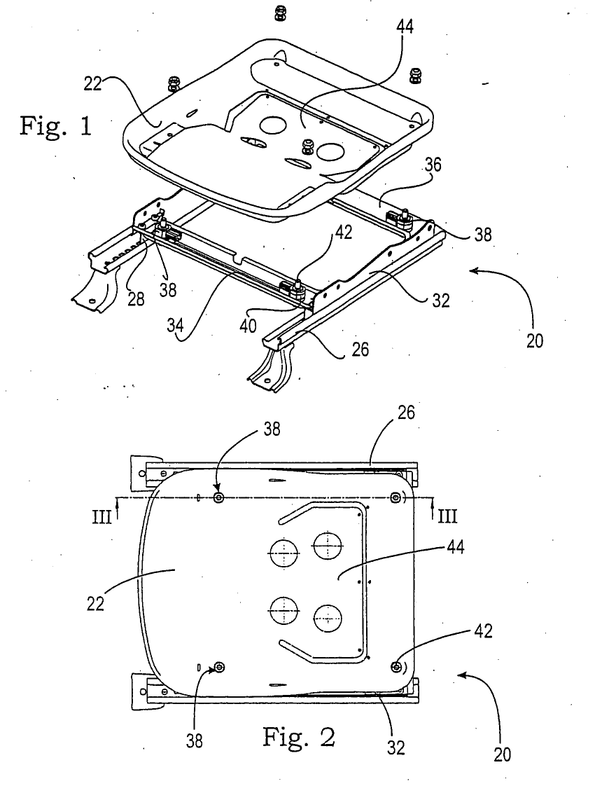

FIG. 1: is a perspective illustration in the form of an assembly drawing of an underframe and a seat pan of a motor vehicle seat,

FIG. 2: is a top view of the parts of the motor vehicle seat in accordance with FIG. 1 in an assembled state and additionally with backrest and padding for the seat pan,

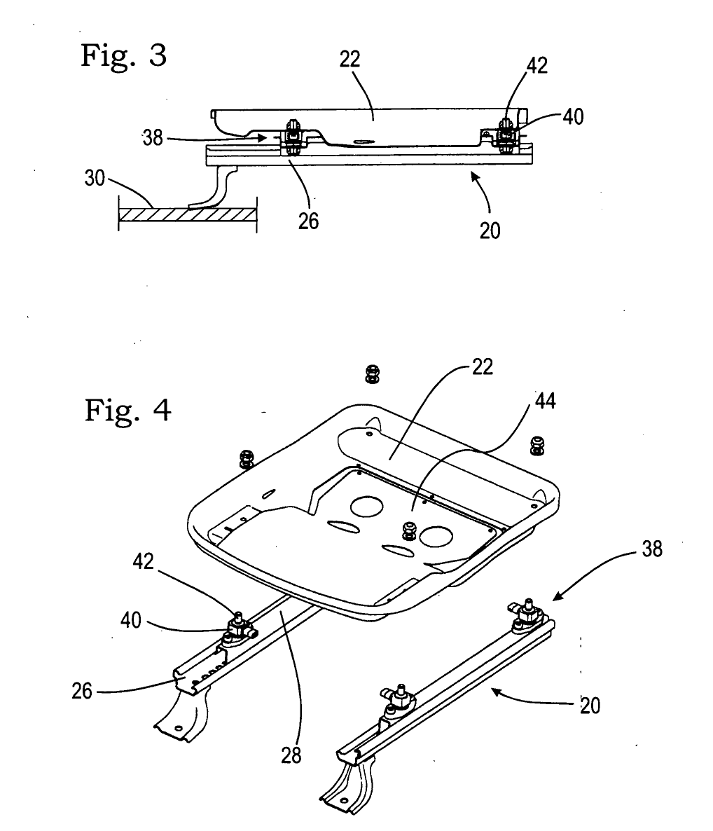

FIG. 3: is a sectional view taken along the line III-III of FIG. 2,

FIG. 4: is an illustration similar to FIG. 1 of a second embodiment,

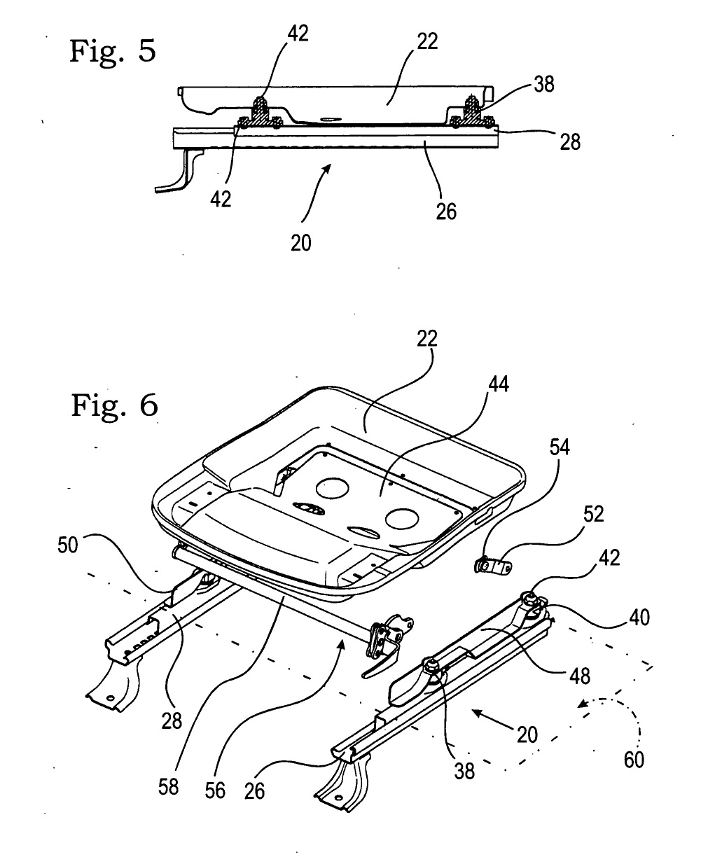

FIG. 5: is a sectional view taken along the line according to FIG. 3 of the configuration according to FIG. 4,

FIG. 6: is an illustration similar to FIG. 1, but this time for a third exemplary embodiment,

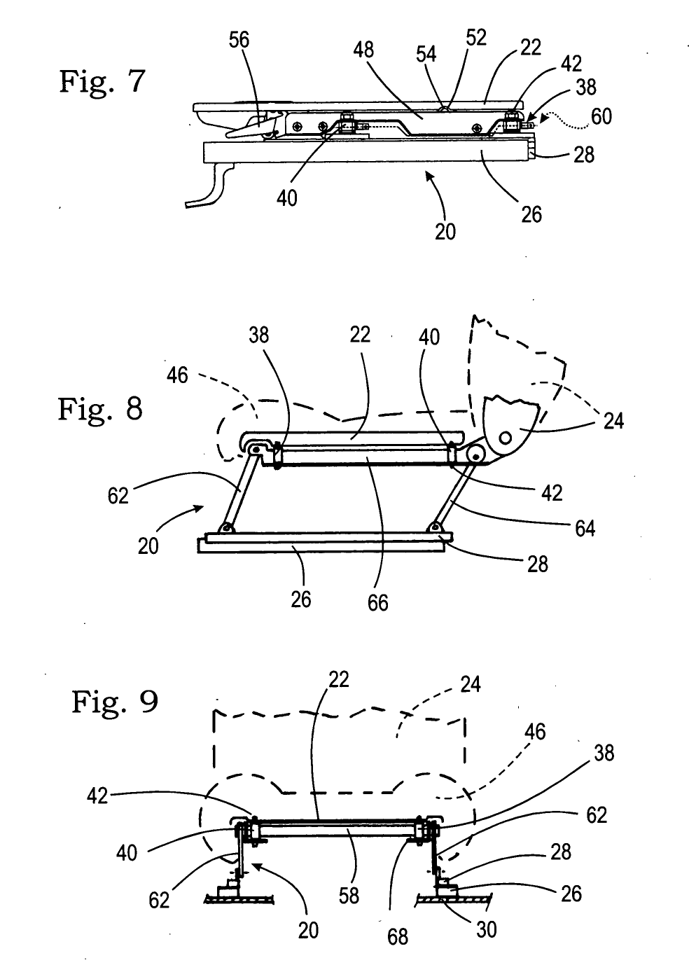

FIG. 7: is a side view of the assembled parts of FIG. 6,

FIG. 8: is a side view of the motor vehicle seat in a fourth embodiment and

FIG. 9 is a front view of a motor vehicle seat as viewed in the direction of travel for a fifth exemplary embodiment.

The exemplary embodiment according to the FIGS. 1 through 3 will be discussed first. The following comments also apply to the other exemplary embodiments unless the description of these other exemplary embodiments explicitly refers to another configuration.

The FIGS. 1 through 3 show a motor vehicle seat with an underframe 20, a seat pan 22 carried by said underframe and a backrest 24. As best shown in FIG. 1, the underframe has a lengthwise adjustment device with two pairs of rails. These two pairs of rails each comprise a floor profile 26 and a seat profile 28. In the instant implementation, the bottom profile 26 surrounds the seat profile 28, the latter being therefore also referred to as the inner rail or the surrounded profile. The floor profile 26 is connected to the underbody 30 of a motor vehicle (not shown) through well known suited means. The two seat profiles 28 have a side region 32 that protrudes upward. In its rear region, it has holes for securing a backrest 24 (see FIGS. 8 and 9).

The two seat profiles 28 are connected by a front tie bar 34 and by a rear tie bar 36. In the exemplary embodiment shown, said tie bars are made from a sheet metal blank and substantially assume a “U” profile. Two weight sensors 38 are disposed on the respective one of the front tie bar 34 and of the rear tie bar 36. They are located in immediate proximity to the two profiles 26, 28 but are offset inward, by for example 10 to 20% of the width of the seat. As can be seen in the FIGS., the weight sensors 38 have a sensor body 40 and two securement regions 42 that are projecting therefrom in opposing directions. In the embodiment according to the FIGS. 1 through 3, the two securement regions 42 are implemented as studs. The sensor body 40 is substantially cylindrical, it is adjoined with an electrical connection region receiving a plug connector (not shown). At the lower securement region 42, the weight sensors 38 are secured in the basis of the respective one of the U-shaped tie bars 34 and 36. Approximately half of the overall height of the weight sensor 38 is thus located beneath the upper edge of the respective one of the tie bars 34 and 36.

The seat pan 22 is only carried through the upper securement regions 42 of the four weight sensors 38. Said seat pan connects to the underframe 20 through said four weight sensors 38 solely. As can be seen from FIG. 1, the seat pan is configured to be a bucket seat, a bucket region 44 in the form of a tongue being capable of moving substantially upward and downward relative to the remainder of the seat pan 22. At the free end of the bucket region 44, springs (not shown) are disposed on the finished seat. Pairs of holes can be seen, said holes receiving ends of the springs which are not illustrated herein. The weight sensors 38 are located on the side, outside of the bucket region 44. They are located on places of the seat pan 22 that are specially shaped upward. As a result, the clearance height needed is as small as possible. The weight sensors 38 are located outside of the actual region in which an occupant has his thighs and buttocks when seated. If one releases the connection between the seat pan 22 and the four weight sensors 38, the seat pan 22 can be completely removed. The seat pan (see FIGS. 2 and 3) is lined with a padding 46 of a well known design. It is implemented in such a manner that it will not mechanically influence weight detection.

In the preferred embodiment, the weight sensor 38 comprises two semiconductor sensor elements that are located within the sensor body 40 by which they are surrounded. One of the two semiconductor sensor elements is thereby located between the two securement regions 42 and senses tensile and compressive strain occurring between said two securement regions 42. The second semiconductor sensor is located in immediate proximity and is built according to much the same building principle as possible without being located in the force path though. Only the difference between the output signals of the two semiconductor sensor elements will be registered. The influence of the ambient temperature onto the semiconductor sensor elements may thus be eliminated.

As opposed to the embodiment in accordance with the FIGS. 1 through 3, the embodiment of the FIGS. 4 and 5 has the seat pan 22 directly connected to the two seat profiles 28 through four weight sensors 38. Accordingly, no tie bars are provided. In their top region, the weight sensors 38 are configured like the weight sensors 28 according to the first exemplary embodiment. The lower securement region 42 however is configured to be a mere flange that is screwed to an upper basis of the seat profile 28 through two lateral screw connections. Like in the first exemplary embodiment, two weight sensors 38 are located in immediate proximity to a front edge of the seat profile 28, two weight sensors 38 being located in immediate proximity to a rear end of the seat profile 28. The seat pan 22 is very similar to the seat pan of the first exemplary embodiment but for the fact that now the securement holes for the upper securement regions 42 are offset a bit more outward according to the arrangement of the weight sensors 38 which are now disposed above the floor profile 26 and are no longer offset a certain distance toward the other floor profile 26. Here, no side regions 32 of the seat profile 28 are provided. The embodiment in accordance with the FIGS. 4 and 5 shows a particularly simple possibility of detecting the weight exerted onto the seat pan 22.

Whereas in the first and second embodiments discussed above the four weight sensors 38 carry the seat pan 22 directly, the four weight sensors 38 in the third exemplary embodiment according to the FIGS. 6 and 7 do not connect directly to the seat pan 22. The weight sensors 28 are not disposed between underframe 20 and seat pan 22 but are located within the underframe 20 instead. Like in the second exemplary embodiment and as opposed to the first exemplary embodiment, two respective weight sensors 38 connect directly to each of the two seat profiles 28. The upper securement regions 42 of the two weight sensors 38 of each seat profile 28 are connected on the left seat side by a left bracket 48 and on the right seat side by a right bracket 50. The seat structure extends upward, starting from said brackets 48, 50. In the instant case, this is achieved through rear pivot arms 52 that are each linked at a lower end region to one of the two tie bars 48, 50 and at an upper end region 54 to the seat pan 22. The pivot arms 52 are linked to the rear end of the respective one of the tie bars 48, 50. A height-adjustment device 56 the design of which is well known is disposed on the left seat side at the front end of the respective one of the tie bars 48, 50 and connects to the right seat side through a transverse tube 58 on which a corresponding arm is disposed.

If one were to cut the weight sensors 38 in the region of their sensor bodies 40 such as by sawing or in any other way, the seat pan 22 with the annexed elements, more specifically with the tie bars 48, 50, could be completely separated from the pairs of rails 26, 28. It is obvious therefrom that the seat pan 22 connects to the two seat profiles 28 through solely the four weight sensors 38. An imaginary parting surface 60 in which lie the bodies 40 of the four weight sensors 38 thus constitutes a parting plane with all of the mechanical connections between seat pan 22 and the two seat profiles 28 having to pass through said parting surface 60 and being realized by the four weight sensors 38 solely. Such an imaginary parting surface 60 may be mentioned for all of the embodiments.

Whereas in the first to third embodiments discussed herein above the four weight sensors 38 are directly connected to the seat profile 28, this is not the case in the following examples. Moreover, in the embodiments discussed above, the backrest is not shown. In the first to third embodiment, it may be secured directly to the seat profile 28, in the third embodiment in accordance with the FIGS. 6 and 7 it may also be secured to the brackets 48, 50, though. In this case, the weight of the backrest 24 and the portion of the occupant's weight bearing on the backrest 24 are registered by the sensors 38. As a result thereof, the weight sensors 38 connect solely mechanically to the backrest 24. Put another way, removal of the weight sensors 38 permits not only to remove freely the seat pan 22 but also the backrest 24.

In the fourth exemplary embodiment according to FIG. 8, the underframe has two front parallelogram arms 62 and two rear parallelogram arms 64. On each seat side, the parallelogram arms 62, 64 of each seat side are joined together at their top through a side part 66 so that a four bar linkage is generally formed on each side. A great variety of such type seats is known. An adjustable hinge mounting is associated with one of the four hinge points, preferably with the upper hinge point, of a rear parallelogram arm 64, in order to permit to adjust and fix the four bar linkage.

The seat pan 22 is connected to the two side parts 66 through four weight sensors 38. As shown in FIG. 8, a lower securement region 42 of a weight sensor 38 is respectively disposed in a front region of each side part 66 and in a rear end region of each side part 66. The side parts 66 are slightly offset downward so that less clearance height is needed. The backrest 24 is disposed immediately on the side parts 66 with a backrest hinge being mounted therein between. Accordingly, in the embodiment according to FIG. 8, the weight of the backrest 24 is not detected.

In the fifth exemplary embodiment according to FIG. 9, the underframe 20 also has front parallelogram arms 62 and additionally thereto also rear parallelogram arms that cannot be seen in the illustration. The following also accordingly applies to the rear parallelogram arms: the upper ends of the parallelogram arms 62 are joined together by a transverse tube 58. The transverse tube 58 traverses a left and a right “L” angle 68 that is linked at a vertical leg to the transverse tube 58. A horizontal leg is located somewhat in front of the transverse tube 58, it receives the lower securement region 42 of a weight sensor 38. An upper securement region 42 of the weight sensor 38 is connected to the seat pan 22. The motion of rotation of the transverse tube 58 is neutralized through the “L” angles 68.

The left parallelogram arms 62, 64 and possibly the left side parts 66 form a left part of a height-adjustment device 56, the right parallelogram arms 62, 64 and possibly the right side part 66 likewise forming a right part of the height-adjustment device. In the third exemplary embodiment, all of the above applies in an analogous manner with the left bracket 48 and the rear left pivot arm 52 belonging to the left part of the height-adjustment device whereas the right bracket 50 and the right rear pivot arm 52 belong to the right part of the height-adjustment device.

1. A motor vehicle seat with an occupant weight detection system, comprising: an underframe that comprises a lengthwise adjustment device with two pairs of rails each comprising a floor profile and a seat profile, a seat pan carried on said underframe and a backrest, wherein between said seat pan and said two seat profiles, there are provided weight sensors that are disposed vertically and detect all of the weight forces exerted from the seat pan downward.

2. The motor vehicle seat according to claim 1, wherein the weight sensors are connected directly to the seat pan.

3. The motor vehicle seat according to claim 1, wherein the weight sensors connect directly to the seat profile.

4. The motor vehicle seat according to claim 15, wherein the two seat profiles are connected to a remainder portion of the underframe, the floor profiles excepted, through solely four of the weight sensors.

5. The motor vehicle seat according to claim 1, wherein each seat profile is connected directly or indirectly to the seat pan through two of the weight sensors solely.

6. The motor vehicle seat according to claim 1, further comprising: at least one tie bar that connects the seat profiles of the two pairs of rails, the tie bar is connected directly or indirectly to the seat pan through solely at least one of the weight sensors.

7. The motor vehicle seat according to claim 1, wherein the underframe comprises a height-adjustment device including a left part and a right part, the seat further comprising at least one carrier member for joining the left part and the right part of the height-adjustment device together said carrier member being connected to the seat pan through at least one of the weight sensors.

8. The motor vehicle seat according to claim 1, wherein the underframe comprises a height-adjustment device including a left part and a right part, said left part and said right part of the height-adjustment device respectively comprise one side part each each side part being connected to at least one of the weight sensors.

9. The motor vehicle seat according to claim 1, wherein the backrest is directly or indirectly connected to the seat profiles and the connection between backrest and seat profiles is solely performed through the weight sensors.

10. The motor vehicle seat according to claim 1, wherein the weight sensors comprises a sensor body and two securement regions.

11. The motor vehicle seat according to claim 1, wherein the sensor body comprises at least one semiconductor sensor element.

12. The motor vehicle seat according to claim 1, further comprising a padding located on the seat pan wherein the seat pan substantially extends over the surface of a seat part of a motor vehicle seat.

13. The motor vehicle seat according to claim 1, further comprising an evaluation circuit to which the weight sensors are connected wherein the evaluation circuit determines a total weight from weight signals delivered by the weight sensors.

14. The motor vehicle seat according to claim 1, wherein the seat pan is connected to the underframe solely through four of the weight sensors.

15. The motor vehicle seat according to claim 3, wherein two of the weight sensors are respectively disposed on each of the two seat profiles.

16. The motor vehicle seat according to claim 6, further comprising two tie bars respectively connected to the seat pan through two of the weight sensors for each tie bar.

17. The motor vehicle seat according to claim 10, wherein the weight sensors further comprise bolts aligned along a same axis which protrude therefrom in opposing directions relative to one another.

18. The motor vehicle seat according to claim 11, wherein the sensor body comprises two semiconductor sensor elements, one sensor element being in a force path and the other sensor element being free of forces.
